(19) United States
(12) Patent Application Publication
(10) Pub. No.: US 2022/0316965 A1
(43) Pub. Date: Oct. 6, 2022

(54) PRESSURE DETECTION APPARATUS, PRESSURE DETECTION SYSTEM, AND METHOD FOR PRODUCING PRESSURE DETECTION APPARATUS

(71) Applicant: NEC Corporation, Minato-ku, Tokyo (JP)

(72) Inventor: Mana HASHIMOTO, Tokyo (JP)

(73) Assignee: NEC Corporation, Minato-ku, Tokyo (JP)

(21) Appl. No.: 17/615,916

(22) PCT Filed: Feb. 27, 2020
(86) PCT No.: PCT/JP2020/007949

§ 371 Date: Dec. 2, 2021

(30) Foreign Application Priority Data
Jun. 3, 2019 (JP) 2019-103564

(51) Int. Cl. G01L 1/20

(52) U.S. Cl. CPC G01L 1/20

(57) ABSTRACT

A pressure sensitive element (110) is located on an upper surface side of a substrate (100), and includes a pressure sensitive layer (114). When the pressure sensitive layer (114) is deformed, an electrical characteristic of the pressure sensitive layer (114) changes. For example, resistance of the pressure sensitive layer (114) changes by deformation. A deformation layer (120) faces the substrate (100) with a plurality of the pressure sensitive layers (114) in between, is deformable in a thickness direction, and includes a plurality of protrusions and recesses. An average value Pi of center-to-center distances of a plurality of protrusions of the deformation layer (120) is equal to or more than one time of a center-to-center distance Po of the pressure sensitive layers (114).

### TECHNICAL FIELD

The present invention relates to a pressure detection apparatus, a pressure detection system, and a method for producing a pressure detection apparatus.

### BACKGROUND ART

As an apparatus for measuring a pressure distribution, for example, there is a piezoelectric pressure distribution sensor described in Patent Document 1. The sensor is such that a plurality of piezoelectric elements are disposed away from one another on a table. A polarization characteristic of a piezoelectric element changes in response to temperature. Therefore, when heat of an object to be measured is transferred to a piezoelectric element, a polarization characteristic of the piezoelectric element changes, and consequently, an error of a detection value of the sensor increases. In the technique described in Patent Document 1, the error described above is decreased by disposing a thermal insulation member on a piezoelectric element.

### RELATED DOCUMENT

### Patent Document

[Patent Document 1] Japanese Unexamined Patent Application Publication No. H2-83425

### SUMMARY OF THE INVENTION

### Technical Problem

The inventor of the present application studied increasing detection accuracy of a region where pressure is applied. One of objects of the present invention is to increase detection accuracy of a region where pressure is applied in a pressure detection apparatus including a plurality of pressure sensitive layers.

### Solution to Problem

The present invention provides a pressure detection apparatus including:

a substrate;

a plurality of pressure sensitive layers that are located on one surface side of the substrate and deform; and

a deformation layer facing the substrate with the plurality of pressure sensitive layers in between, being deformable in a thickness direction, and including a plurality of protrusions and recesses, wherein,

when the pressure sensitive layer is deformed, an electrical characteristic of the pressure sensitive layer changes, and

an average value of center-to-center distances of protrusions in the protrusions and the recesses of the deformation layer is equal to or more than one time of a center-to-center distance of the pressure sensitive layers.

The present invention provides a pressure detection apparatus including:

a substrate;

a pressure sensitive layer being located on one surface side of the substrate; and

a deformation layer facing the substrate with the pressure sensitive layer in between, being deformable in a thickness direction, and including a plurality of protrusions and recesses, wherein,

when the pressure sensitive layer is deformed, an electrical characteristic of the pressure sensitive layer changes, and

an amount of change in a thickness of the deformation layer when pressure applied to the deformation layer is 0.01 kg/cm² is equal to or more than 3 μm.

The present invention provides a pressure detection apparatus including:

a substrate;

a pressure sensitive layer being located on one surface side of the substrate; and

a deformation layer facing the substrate with a plurality of the pressure sensitive layers in between, being deformable in a thickness direction, and including a plurality of protrusions and recesses, wherein resistance of the pressure sensitive layer changes by deformation.

The present invention provides a method for producing a pressure detection apparatus including:

preparing a pressure detection unit including a substrate, and a plurality of pressure sensitive layers being located on one surface side of the substrate; and

arranging, over the pressure sensitive layer, a deformation layer being deformable in a thickness direction, and including a plurality of protrusions and recesses, wherein,

when the pressure sensitive layer is deformed, an electrical characteristic of the pressure sensitive layer changes, and

an average value of center-to-center distances of protrusions in the protrusions and the recesses of the deformation layer is equal to or more than one time of a center-to-center distance of the pressure sensitive layers.

### Advantageous Effects of Invention

According to the present invention, in a pressure detection apparatus including a plurality of pressure sensitive layers, detection accuracy of a region where pressure is applied is increased.

### BRIEF DESCRIPTION OF THE DRAWINGS

The above-described object, the other objects, features, and advantages will become more apparent from suitable example embodiments described below and the following accompanying drawings.

FIG. 1 is a cross-sectional view illustrating a configuration of a pressure detection apparatus according to a first example embodiment.

FIG. 2 is a plan view illustrating a layout of a plurality of pressure sensitive elements included in the pressure detection apparatus.

FIG. 3A illustrates a distribution of output values (single pixel intensities) of a plurality of cells in a case where a can for beverage whose internal capacity is 350 ml is placed on the pressure detection apparatus, and FIG. 3B illustrates a distribution of output values of a plurality of cells in a case where an operation similar to FIG. 3A is performed in a state that a deformation layer is removed from the pressure detection apparatus.

FIG. 4 is a table illustrating a relation among a kind and a characteristic of a deformation layer, and detection accuracy (sensitivity) of the pressure detection apparatus.

FIG. 5 is a cross-sectional view illustrating a configuration of a pressure detection apparatus according to a second example embodiment.

FIG. 6 is a cross-sectional view illustrating a configuration of a pressure detection apparatus according to a third example embodiment.

FIG. 7 is a diagram illustrating a configuration of a pressure detection system according to a fourth example embodiment.

FIG. 8 is a block diagram illustrating a hardware configuration of a signal processing unit.

FIG. 9 is a cross-sectional view illustrating a configuration of a pressure detection apparatus according to a modification example.

### DESCRIPTION OF EMBODIMENTS

Hereinafter, example embodiments according to the present invention are described with reference to the drawings. Note that, in all the drawings, a similar constituent element is indicated by a similar reference sign, and description thereof is omitted as necessary.

### First Example Embodiment

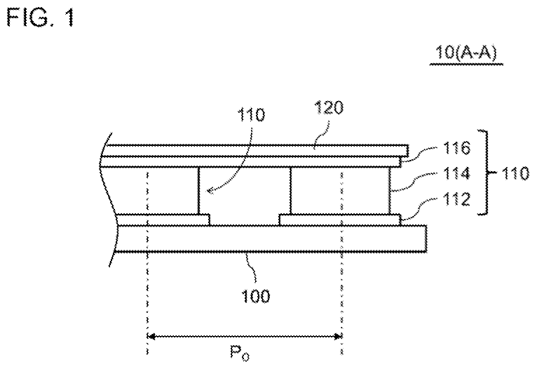

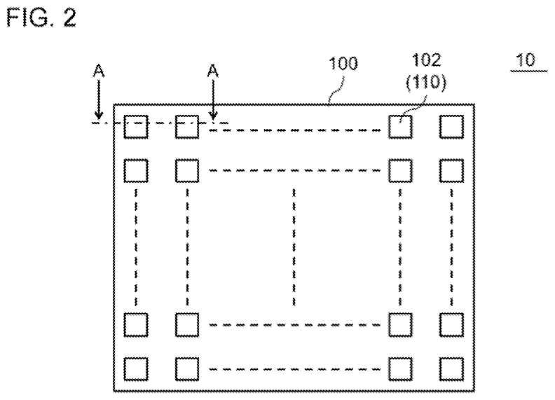

FIG. 1 is a cross-sectional view illustrating a configuration of a pressure detection apparatus 10 according to a present example embodiment. FIG. 2 is a plan view illustrating a layout of a plurality of pressure sensitive elements 110 included in the pressure detection apparatus 10. FIG. 1 is equivalent to a cross section taken along a line A-A in FIG. 2.

The pressure detection apparatus 10 is an apparatus for measuring a pressure distribution, and includes a substrate 100, a plurality of pressure sensitive elements 110, and a deformation layer 120. Each of the pressure sensitive elements 110 is located on one surface side (hereinafter, referred to as an upper surface side) of the substrate 100, and includes a pressure sensitive layer 114. In a plan view, each of the plurality of pressure sensitive elements 110 is located at a position different from one another on one surface side of the substrate 100. For example, the pressure sensitive elements 110 are arranged in an array over the pressure sensitive element 110. When the pressure sensitive layer 114 is deformed, an electrical characteristic of the pressure sensitive layer 114 changes. For example, resistance of the pressure sensitive layer 114 changes by deformation of the pressure sensitive layer 114. The deformation layer 120 faces the substrate 100 with a plurality of the pressure sensitive layers 114 in between, is deformable in a thickness direction, and includes a plurality of protrusions and recesses. An average value P₁ of center-to-center distances of a plurality of protrusions of the deformation layer 120 is equal to or more than one time of a center-to-center distance P₀ of the pressure sensitive layers 114. Herein, a center-to-center distance of protrusions indicates a distance, when the substrate 100 is viewed from a plan view, from a center of a certain protrusion to a center of a protrusion adjacent thereto. Further, a center-to-center distance of the pressure sensitive layers 114 is similarly, and indicates a distance, when the substrate 100 is viewed from a plan view, from a center of a certain pressure sensitive layer 114 to a center of a pressure sensitive layer 114 adjacent thereto. The average value P₁ of center-to-center distances of a plurality of protrusions of the deformation layer 120 is preferably equal to or less than twelve times of the center-to-center distance P₀ of the pressure sensitive layers 114. Further, an amount of change in a thickness of the deformation layer 120 when pressure applied to the deformation layer 120 is 0.01 kg/cm² is 3 μm or more. Hereinafter, the pressure detection apparatus 10 is described in detail.

The substrate 100 is a film substrate such as, for example, a polyester film such as PET or PEN, a polyacrylic film such as PMMA, and a polyimide film. However, the substrate 100 is not limited to a film substrate.

A wiring and an element are provided over an upper surface of the substrate 100. These wiring and element are provided for reading a change in an electrical characteristic of the pressure sensitive element 110. For example, in a case of an active type apparatus, a transistor (e.g., a TFT) and a wiring are provided on an upper surface of the substrate 100. These transistors are provided for each of the pressure sensitive elements 110. A layout of these transistors and wirings is, for example, similar to that of a TFT and a wiring included in a liquid crystal display.

Further, in a case of a passive type apparatus, each of a first electrode 112 and a second electrode 116 serves as a wiring. Specifically, the first electrode 112 and the second electrode 116 extend in directions orthogonal to each other. Then, the pressure sensitive layer 114 is formed at an intersection of these wirings.

A plurality of the pressure sensitive elements 110 are located over an upper surface of the substrate 100. Each of the pressure sensitive elements 110 is provided for measuring a distribution of pressure applied to the pressure detection apparatus 10, and arranged, for example, two-dimensionally and at a regular interval. The center-to-center distance (specifically, a center-to-center distance of the pressure sensitive layers 114) P₀ of the pressure sensitive elements 110 is not particularly limited, as far as it is possible to determine a shape of an article to be placed on the pressure detection apparatus 10. However, an excessively small P₀ may increase the number of sensors on the entirety of a sheet, and (a reading circuit) may become complicated. Conversely, since an excessively large P₀ may make it impossible to determine an article, it is necessary to set P₀ to an appropriate value depending on an article to be determined. In a case of a general article, for example, P₀ is preferably 20 μm or more and 50 mm or less, desirably, 50 μm or more and 10 mm or less, and more preferably, 200 μm or more and 5 mm or less.

A pressure applied to the pressure detection apparatus 10 is measured in the unit of a cell 102. The cell 102 includes at least one pressure sensitive element 110. In a case where the cell 102 has one pressure sensitive element 110, pressure applied to the cell 102 is determined by a change in resistance of the pressure sensitive element 110. On the other hand, in a case where the cell 102 has a plurality of the pressure sensitive elements 110, pressure applied to the cell 102 is determined by a value (e.g., an average value) acquired by statistically processing a change in resistance of the plurality of these pressure sensitive elements 110. Further, in a case where the cell 102 is constituted of a plurality of the pressure sensitive elements 110, the center-to-center distance P₁ of the cells 102 is not particularly limited, as far as it is possible to determine a shape of an article to be placed on the pressure detection apparatus 10. However, an excessively small P₁ may increase the number of sensors on the entirety of a sheet, and (a reading circuit) may become complicated. Conversely, since an excessively large P₁ may make it impossible to determine an article, it is necessary to set P₁ to an appropriate value depending on an article to be determined. In a case of a general article, for example, P₁ is preferably 20 μm or more and 50 mm or less, desirably, 50 μm or more and 10 mm or less, and more preferably, 200 μm or more and 5 mm or less.

The pressure sensitive element 110 includes the first electrode 112, the pressure sensitive layer 114, and the second electrode 116. The first electrode 112 and the second electrode 116 are provided for measuring (reading) a change in an electrical characteristic of the pressure sensitive layer 114.

The pressure sensitive layer 114 is, for example, the one in which a conductive particle (e.g., metal particle) is mixed in elastically deformable resin (e.g., rubber). In this case, resistance of the pressure sensitive layer 114 changes by deformation. The pressure sensitive layer 114 is, for example, formed by using a printing method or an ink jet method. However, the pressure sensitive layer 114 may be directly formed on the first electrode 112 by using a printing method, or an individually fabricated pressure sensitive layer 114 may be placed over the first electrode 112.

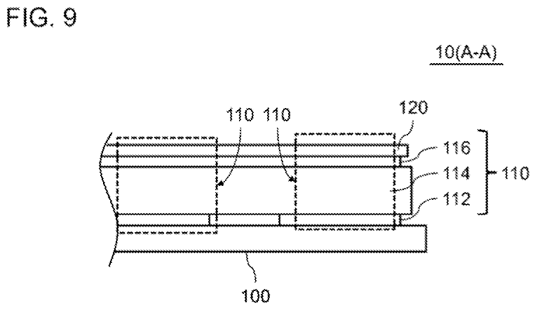

Note that, in the example illustrated in FIG. 1, the pressure sensitive layer 114 is formed for each pressure sensitive element 110. However, as illustrated in FIG. 9, adjacent pressure sensitive layers 114 may be continued to each other among at least a part of the pressure sensitive elements 110 (preferably, all pressure sensitive elements 110). In this case, a plurality of the pressure sensitive layers 114 included in the pressure detection apparatus 10 can be formed by one sheet.

In the example illustrated in FIG. 1, the first electrode 112 and the second electrode 116 also serve as a wiring. The first electrode 112 extends, for example, in the up-down direction in FIG. 2, and the second electrode 116 extends, for example, in the left-right direction in FIG. 2. For example, the second electrode 116 is the one in which a conductive layer is formed over one surface (lower surface in FIG. 1) of a flexible base member. The first electrode 112, and a conductive layer of the second electrode 116 are, for example, formed by using conductive ink. Therefore, both of the first electrode 112 and the second electrode 116 can be formed by using a printing method or an ink jet method.

The deformation layer 120 is formed over the second electrode 116. The deformation layer 120 is formed for absorbing a height variation of an upper surface of the pressure sensitive layer 114. By forming the deformation layer 120, accuracy of a pressure distribution to be measured by the pressure detection apparatus 10 is increased. For example, the deformation layer 120 is the one in which a plurality of fibrous materials such as cloth, non-woven fabric, or paper overlap in a mesh shape, and is deformed by pressure application. The fibrous material may be produced by using a plant, or may be produced by using an artificially synthesized material, for example, a polymer.

A thickness of the deformation layer 120 is, for example, less than 3 mm, and preferably, less than 2 mm. An excessively large thickness of the deformation layer 120 may lower accuracy of a pressure distribution to be measured by the pressure detection apparatus 10, because pressure applied from above a certain pressure sensitive element 110 is distributed to an adjacent pressure sensitive element 110 via the deformation layer 120. Further, a thickness of the deformation layer 120 is, for example, 0.5 mm or more. In a case where a thickness of the deformation layer 120 is 0.5 mm or less, a height variation of an upper surface of the pressure sensitive layer 114 may not be absorbed by the deformation layer 120. Note that, as described in other example embodiments to be described later, in a case where the pressure detection apparatus 10 is provided on a shelf where a merchandise or a product is placed, it is preferable to set an amount of change in a thickness of the deformation layer 120 when pressure applied to the deformation layer 120 is 0.01 kg/cm² to 3 μm or more. A deformation amount of 3 μm or more (75% or more with respect to a height variation of an upper surface of the pressure sensitive layer 114) enables sufficiently absorbing a height variation (e.g., 4 μm) of the upper surface of the pressure sensitive layer 114.

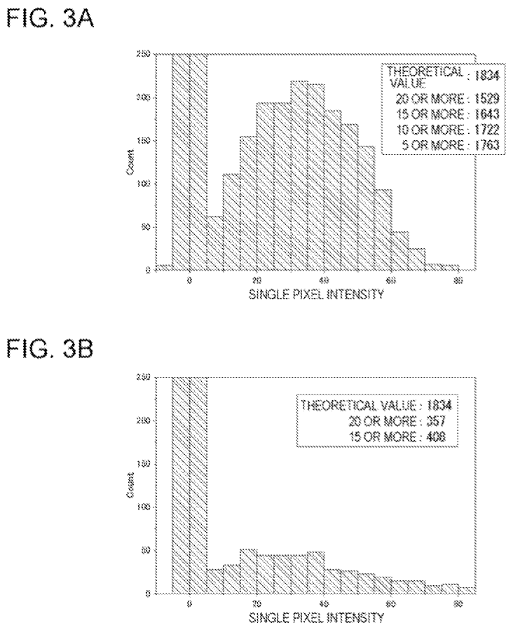

FIG. 3A illustrates a distribution of output values (single pixel intensities) of a plurality of cells 102 in a case where a can for beverage whose internal capacity is 350 ml is placed on the pressure detection apparatus 10. In the example illustrated in the present drawing, a Kimtowel (registered trademark) was used as the deformation layer 120. FIG. 3B illustrates a distribution of output values of a plurality of cells 102 in a case where an operation similar to FIG. 3A was performed in a state that the deformation layer 120 was removed from the pressure detection apparatus 10. Note that, a theoretical value=1834 indicates the number of cells 102 that overlap a bottom surface of the can.

Comparison between FIG. 3A and FIG. 3B reveals that, by forming the deformation layer 120, the number of cells 102 whose output values are large drastically increases, and approaches a theoretical value. In a case where a planar distribution of cells 102 whose output values are equal to or more than a reference value is illustrated, the distribution of cells 102 is closely approximate to a shape of a bottom surface of the can. In this way, forming the deformation layer 120 increases detection accuracy of the pressure detection apparatus 10.

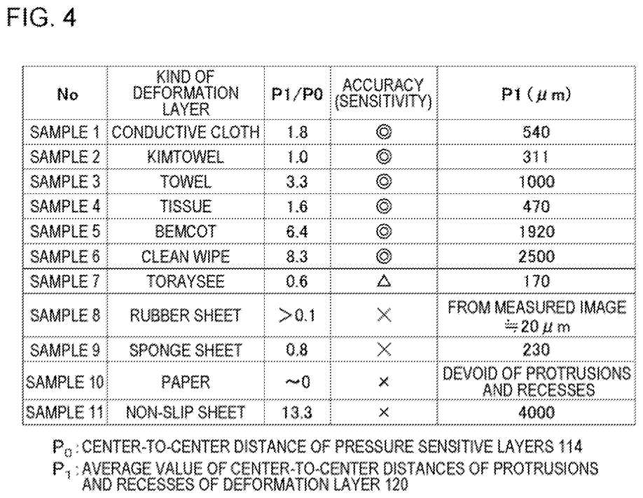

FIG. 4 is a table illustrating a relation among a kind and a characteristic of the deformation layer 120, and detection accuracy (sensitivity) of the pressure detection apparatus 10. As the deformation layer 120, conductive cloth (sample 1), a Kimtowel (registered trademark) (sample 2), a towel (sample 3), a tissue (sample 4), a Bemcot (registered trademark) (sample 5), a clean wipe (sample 6), a Toraysee (registered trademark) (sample 7), a rubber sheet (sample 8), a sponge sheet (sample 9), paper (sample 10), and a non-slip sheet (sample 11) were used. Further, as a characteristic of the deformation layer 120, the center-to-center distance P₁ of the pressure sensitive layers 114 was cited. Note that, the center-to-center distance P₀ of the pressure sensitive layers 114 was 300 μm.

In the samples 1 to 6, since P₁/P₀ was one or more times, detection accuracy (sensitivity) of the pressure detection apparatus 10 was good. On the other hand, in the samples 7 to 10, since P₁/P₀ was less than one, detection accuracy (sensitivity) of the pressure detection apparatus 10 was not good. Further, since P₁/P₀ of the sample 11 exceeded twelve (13.3), in the sample 11, detection accuracy (sensitivity) of the pressure detection apparatus 10 was not good.

As described above, in the present example embodiment, the deformation layer 120 is formed above the pressure sensitive layer 114. The deformation layer 120 absorbs a height variation of an upper surface of the pressure sensitive layer 114. Therefore, accuracy of a pressure distribution to be measured by the pressure detection apparatus 10 is increased. In particular, in a case where the deformation layer 120 is formed by using ink, a height of an upper surface of the deformation layer 120 varies to some extent. Therefore, the above-described advantageous effect by the deformation layer 120 is particularly increased.

### Second Example Embodiment

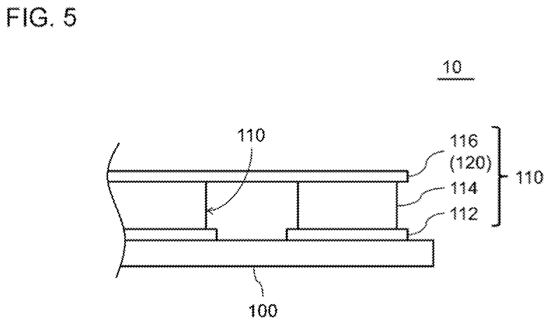

FIG. 5 is a cross-sectional view illustrating a configuration of a pressure detection apparatus 10 according to a present example embodiment, and is associated with FIG. 1 of the first example embodiment. The pressure detection apparatus 10 according to the present example embodiment has a configuration similar to the configuration of the pressure detection apparatus 10 according to the first example embodiment except for a point that a second electrode 116 also serves as a deformation layer 120.

More specifically, a surface of the second electrode 116 at least in contact with a pressure sensitive layer 114 is made of conductive cloth. Therefore, a height variation of an upper surface of the pressure sensitive layer 114 is absorbed by the pressure sensitive layer 114. Thus, an advantageous effect similar to the first example embodiment is also acquired by the present example embodiment.

### Third Example Embodiment

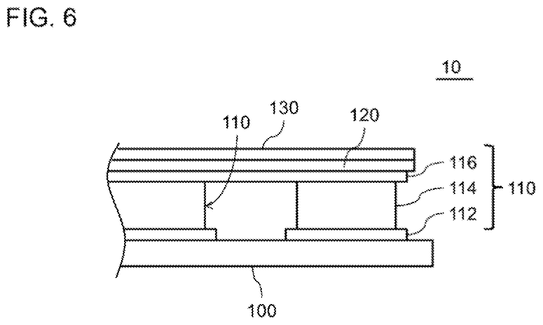

FIG. 6 is a cross-sectional view illustrating a configuration of a pressure detection apparatus 10 according to a present example embodiment, and is associated with FIG. 1 of the first example embodiment. The pressure detection apparatus 10 according to the present example embodiment has a configuration similar to the configuration of the pressure detection apparatus 10 according to the first example embodiment except for a point that the pressure detection apparatus 10 includes a protection layer 130.

The protection layer 130 faces a pressure sensitive layer 114 with a deformation layer 120 in between, and has flexibility. The protection layer 130 is formed for protecting the deformation layer 120 from friction against an object to be placed on the pressure detection apparatus 10. The protection layer 130 is, for example, a resin film such as plastic, cloth, and the like, and a thickness thereof is, for example, 0.1 mm or more and 5 mm or less, and preferably, 2 mm or less. However, a material and a thickness of the protection layer 130 are not limited to these.

Note that, the protection layer 130 may be formed in the pressure detection apparatus 10 according to the second example embodiment.

Also in the present example embodiment, an advantageous effect similar to the first example embodiment is acquired. Further, the protection layer 130 is formed above the deformation layer 120. Therefore, durability of the deformation layer 120 is improved.

### Fourth Example Embodiment

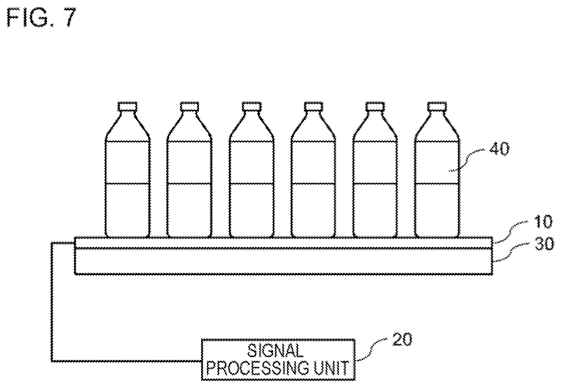

FIG. 7 is a diagram illustrating a configuration of a pressure detection system according to a present example embodiment. The pressure detection system includes a pressure detection apparatus 10 and a signal processing unit 20.

The pressure detection apparatus 10 has a configuration similar to any of the first to third example embodiments. The 10 is provided on an upper surface side of a shelf 30. The shelf 30 is provided, for example, in a facility where an object 40 is needed to be managed, such as a store, a distribution center, or a factory. The object 40 to be placed on the shelf 30 is, for example, a merchandise, a product, or a part.

Then, the signal processing unit 20 generates, by using a change in an electrical characteristic of a plurality of the pressure sensitive layers 114, and outputs information indicating a position of a pressure sensitive layer 114 to which pressure is applied. The information is, for example, an image (map) indicating a distribution of pressure applied to the pressure detection apparatus 10. The image indicates a portion of the pressure detection apparatus 10 where the object 40 is placed, specifically, a shape of a bottom surface of the object 40. Note that, the signal processing unit 20 may be configured by a plurality of data processing units.

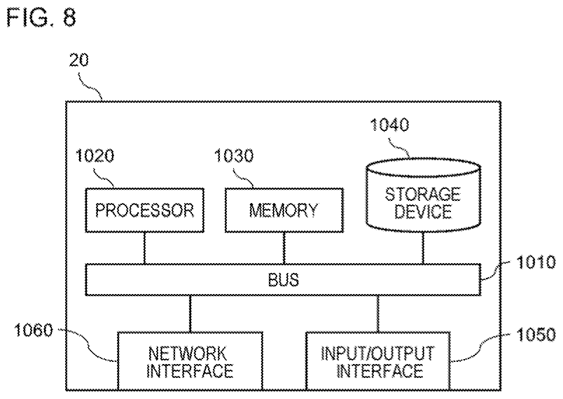

FIG. 8 is a block diagram illustrating a hardware configuration of the signal processing unit 20. The signal processing unit 20 includes a bus 1010, a processor 1020, a memory 1030, a storage device 1040, an input/output interface 1050, and a network interface 1060.

The bus 1010 is a data transmission path along which the processor 1020, the memory 1030, the storage device 1040, the input/output interface 1050, and the network interface 1060 mutually transmit and receive data. However, a method for mutually connecting the processor 1020 and the like is not limited to bus connection.

The processor 1020 is a processor to be achieved by a central processing unit (CPU), a graphics processing unit (GPU), or the like.

The memory 1030 is a main storage apparatus to be achieved by a random access memory (RAM) or the like.

The storage device 1040 is an auxiliary storage apparatus to be achieved by a hard disk drive (HDD), a solid state drive (SSD), a memory card, a read only memory (ROM), or the like. The storage device 1040 stores a program module that achieves each function of the signal processing unit 20. The processor 1020 achieves each function associated with a program module by reading each of these program modules in the memory 1030 and executing each of these program modules.

The input/output interface 1050 is an interface for connecting the signal processing unit 20 and various input/output devices.

The network interface 1060 is an interface for connecting the signal processing unit 20 to a network. The network is, for example, a local area network (LAN), or a wide area network (WAN). A method for connecting the network interface 1060 to a network may be wireless connection or may be wired connection.

A control apparatus for controlling the pressure detection apparatus 10 may be provided separately of the signal processing unit 20. In this case, the pressure detection apparatus 10 and the signal processing unit 20 are connected to each other, for example, via a signal line or wireless communication.

In the foregoing, in the present example embodiment, the pressure detection apparatus 10 is provided over an upper surface of the shelf 30. Then, the signal processing unit 20 generates, by using a detection value of the pressure detection apparatus 10, information indicating a position of the pressure sensitive layer 114 to which pressure is applied. The information indicates a portion of the shelf 30 where the object 40 is placed. Therefore, using information to be output from the signal processing unit 20 enables determining a position of the object 40 and the number of objects 40.

In the foregoing, example embodiments according to the present invention have been described with reference to the drawings, however, these are examples of the present invention, and various configurations other than the above can be adopted. For example, the deformation layer 120 may be formed on a side of a surface (e.g., a lower surface in FIG. 1) opposite to the 110 of the substrate 100.

A part or all of the above-described example embodiments may also be described as the following supplementary notes, but is not limited to the following.

1. A pressure detection apparatus including:

a substrate;

a plurality of pressure sensitive layers being located on one surface side of the substrate; and

a deformation layer facing the substrate with the plurality of pressure sensitive layers in between, being deformable in a thickness direction, and including a plurality of protrusions and recesses, wherein,

when the pressure sensitive layer is deformed, an electrical characteristic of the pressure sensitive layer changes, and

an average value of center-to-center distances of protrusions in the protrusions and the recesses of the deformation layer is equal to or more than one time of a center-to-center distance of the pressure sensitive layers.

2. The pressure detection apparatus according to supplementary note 1, wherein

an average value of center-to-center distances of a plurality of the protrusions of the deformation layer is equal to or less than twelve times of a center-to-center distance of the pressure sensitive layers.

3. A pressure detection apparatus including:

a substrate;

a pressure sensitive layer being located on one surface side of the substrate; and

a deformation layer facing the substrate with the plurality of pressure sensitive layers in between, being deformable in a thickness direction, and including a plurality of protrusions and recesses, wherein,

when the pressure sensitive layer is deformed, an electrical characteristic of the pressure sensitive layer changes, and

an amount of change in a thickness of the deformation layer when pressure applied to the deformation layer is 0.01 kg/cm2 is equal to or more than 3

4. A pressure detection apparatus including:

a substrate;

a plurality of pressure sensitive layers being located on one surface side of the substrate; and

a deformation layer facing the substrate with the plurality of pressure sensitive layers in between, being deformable in a thickness direction, and including a plurality of protrusions and recesses, wherein

resistance of the pressure sensitive layer changes by deformation.

5. The pressure detection apparatus according to any one of supplementary notes 1 to 4, further including

a protection layer facing the pressure sensitive layer with the deformation layer in between, and having flexibility.

6. The pressure detection apparatus according to any one of supplementary notes 1 to 5, wherein

the deformation layer is formed by using ink.

7. The pressure detection apparatus according to any one of supplementary notes 1 to 6, wherein

a thickness of the deformation layer is equal to or less than 3 mm.

8. The pressure detection apparatus according to supplementary note 7, wherein

a thickness of the deformation layer is less than 2 mm.

9. The pressure detection apparatus according to any one of supplementary notes 1 to 8, wherein

a center-to-center distance of the pressure sensitive layers is equal to or more than 50 and equal to or less than 2 mm.

10. The pressure detection apparatus according to any one of supplementary notes 1 to 9, further including

being provided on an upper surface side of a shelf on which an object is placed.

11. A pressure detection system including:

the pressure detection apparatus according to any one of supplementary notes 1 to 10; and

a signal processing unit for generating, by using a change in an electrical characteristic of the plurality of pressure sensitive layers, information indicating a position of the pressure sensitive layer to which pressure is applied.

12. A method for producing a pressure detection apparatus including:

preparing a pressure detection unit including a substrate, and a plurality of pressure sensitive layers being located on one surface side of the substrate; and

arranging, over the pressure sensitive layer, a deformation layer being deformable in a thickness direction, and including a plurality of protrusions and recesses, wherein,

when the pressure sensitive layer is deformed, an electrical characteristic of the pressure sensitive layer changes, and

an average value of center-to-center distances of protrusions in the protrusions and the recesses of the deformation layer is equal to or more than one time of a center-to-center distance of the pressure sensitive layers.

13. The method for producing the pressure detection apparatus according to supplementary note 12, wherein

an average value of center-to-center distances of a plurality of the protrusions of the deformation layer is equal to or less than twelve times of a center-to-center distance of the pressure sensitive layers.

14. A method for producing a pressure detection apparatus including:

preparing a pressure detection unit including a substrate, and a plurality of pressure sensitive layers being located on one surface side of the substrate; and

arranging, over the pressure sensitive layer, a deformation layer being deformable in a thickness direction, and including a plurality of protrusions and recesses, wherein,

when the pressure sensitive layer is deformed, an electrical characteristic of the pressure sensitive layer changes, and

an amount of change in a thickness of the deformation layer when pressure applied to the deformation layer is 0.01 kg/cm2 is equal to or more than 3

15. A method for producing a pressure detection apparatus including:

preparing a pressure detection unit including a substrate, and a plurality of pressure sensitive layers being located on one surface side of the substrate; and

arranging, over the pressure sensitive layer, a deformation layer being deformable in a thickness direction, and including a plurality of protrusions and recesses, wherein

resistance of the pressure sensitive layer changes by deformation.

16. The method for producing the pressure detection apparatus according to any one of supplementary notes 12 to 15, further including

forming a protection layer facing the pressure sensitive layer with the deformation layer in between, and having flexibility.

17. The method for producing the pressure detection apparatus according to any one of supplementary notes 12 to 16, wherein

the deformation layer is formed by using ink.

18. The method for producing the pressure detection apparatus according to any one of supplementary notes 12 to 17, wherein

a thickness of the deformation layer is equal to or less than 3 mm.

19. The method for producing the pressure detection apparatus according to supplementary note 18, wherein

a thickness of the deformation layer is less than 2 mm.

20. The method for producing the pressure detection apparatus according to any one of supplementary notes 12 to 19, wherein

a center-to-center distance of the pressure sensitive layers is equal to or more than 50 μm and equal to or less than 2 mm.

21. The method for producing the pressure detection apparatus according to any one of supplementary notes 12 to 20, wherein

the pressure detection apparatus is provided on an upper surface side of a shelf on which an object is placed.

This application is based upon and claims the benefit of priority from Japanese patent application No. 2019-103564, filed on Jun. 3, 2019, the disclosure of which is incorporated herein in its entirety by reference.

### REFERENCE SIGNS LIST

10 Pressure detection apparatus
20 Signal processing unit
30 Shelf
40 Object
100 Substrate
102 Cell
110 Pressure sensitive element
112 First electrode
114 Pressure sensitive layer
116 Second electrode
120 Deformation layer
130 Protection layer

What is claimed is:

1. A pressure detection apparatus comprising:
a substrate;
a plurality of pressure sensitive layers being located on one surface side of the substrate; and
a deformation layer facing the substrate with the plurality of pressure sensitive layers in between, being deformable in a thickness direction, and including a plurality of protrusions and recesses, wherein,
when the pressure sensitive layer is deformed, an electrical characteristic of the pressure sensitive layer changes, and
an average value of center-to-center distances of protrusions in the protrusions and the recesses of the deformation layer is equal to or more than one time of a center-to-center distance of the pressure sensitive layers.

2. The pressure detection apparatus according to claim 1, wherein
an average value of center-to-center distances of a plurality of the protrusions of the deformation layer is equal to or less than twelve times of a center-to-center distance of the pressure sensitive layers.

3.-4. (canceled)

5. The pressure detection apparatus according to claim 1, further comprising
a protection layer facing the pressure sensitive layer with the deformation layer in between, and having flexibility.

6. The pressure detection apparatus according to claim 1, wherein
the plurality of pressure sensitive layers are formed by using ink.

7. The pressure detection apparatus according to claim 1, wherein
a thickness of the deformation layer is equal to or less than 3 mm.

8. The pressure detection apparatus according to claim 7, wherein
a thickness of the deformation layer is less than 2 mm.

9. The pressure detection apparatus according to claim 1, wherein
a center-to-center distance of the pressure sensitive layers is equal to or more than 20 μm and equal to or less than 2-50 mm.

10. The pressure detection apparatus according to claim 1, wherein
the pressure detection apparatus is provided on an upper surface side of a shelf on which an object is placed.

11. A pressure detection system comprising:
the pressure detection apparatus according to claim 1; and
signal processing unit for generating, by using a change in an electrical characteristic of the plurality of pressure sensitive layers, information indicating a position of the pressure sensitive layer to which pressure is applied.

12. A method for producing a pressure detection apparatus comprising:
preparing a pressure detection unit including a substrate, and a plurality of pressure sensitive layers being located on one surface side of the substrate; and
arranging, over the pressure sensitive layer, a deformation layer being deformable in a thickness direction, and including a plurality of protrusions and recesses, wherein,
when the pressure sensitive layer is deformed, an electrical characteristic of the pressure sensitive layer changes, and
an average value of center-to-center distances of protrusions in the protrusions and the recesses of the deformation layer is equal to or more than one time of a center-to-center distance of the pressure sensitive layers.

13. The method for producing the pressure detection apparatus according to claim 12, wherein
an average value of center-to-center distances of a plurality of the protrusions of the deformation layer is equal to or less than twelve times of a center-to-center distance of the pressure sensitive layers.

14. The method for producing the pressure detection apparatus according to claim 12, further including
forming a protection layer facing the pressure sensitive layer with the deformation layer in between, and having flexibility.

15. The method for producing the pressure detection apparatus according to claim 12, wherein
the plurality of pressure sensitive layers are formed by using ink.

16. The method for producing the pressure detection apparatus according to claim 12, wherein
a thickness of the deformation layer is equal to or less than 3 mm.

17. The method for producing the pressure detection apparatus according to claim 16, wherein
a thickness of the deformation layer is less than 2 mm.

18. The method for producing the pressure detection apparatus according to claim 12, wherein
a center-to-center distance of the pressure sensitive layers is equal to or more than 20 μm and equal to or less than 50 mm.

19. The method for producing the pressure detection apparatus according to claim 12, wherein
the pressure detection apparatus is provided on an upper surface side of a shelf on which an object is placed.
